(19) United States
(12) Patent Application Publication
(10) Pub. No.: US 2022/0352502 A1
(43) Pub. Date: Nov. 3, 2022

(54) POSITIVE ELECTRODE FOR RECHARGEABLE LITHIUM BATTERY AND RECHARGEABLE LITHIUM BATTERY INCLUDING THE SAME

(71) Applicant: Samsung SDI Co., Ltd., Yongin-si (KR)

(72) Inventors: San MOON, Yongin-si (KR); Duckjae YOU, Yongin-si (KR); Jihyun JANG, Yongin-si (KR); Seongho JEON, Yongin-si (KR)

(21) Appl. No.: 17/692,704

(22) Filed: Mar. 11, 2022

(30) Foreign Application Priority Data
Mar. 12, 2021 (KR) 10-2021-0032811

(51) Int. Cl. H01M 4/36; H01M 4/505; H01M 4/525; H01M 4/485; H01M 4/58; H01M 10/0525

(52) U.S. Cl. CPC H01M 4/364; H01M 4/505; H01M 4/525; H01M 4/485; H01M 4/5825; H01M 10/0525; H01M 2004/021

(57) ABSTRACT

Provided are a positive electrode for a rechargeable lithium battery and a rechargeable lithium battery including the same. The positive electrode for a rechargeable lithium battery includes a current collector, a first positive electrode active material layer on the current collector and including a first positive electrode active material, and a second positive electrode active material layer on the first positive electrode active material layer and including a second positive electrode active material, wherein the first positive electrode active material layer includes ceramic particles, a particle diameter of each of the ceramic particles is in a range from about 10 nm to about 500 nm, and the ceramic particles are included only in the first positive electrode active material layer.

### CROSS-REFERENCE TO RELATED APPLICATION

This application claims priority to and the benefit of Korean Patent Application No. 10-2021-003281 1 filed in the Korean Intellectual Property Office on Mar. 12, 2021, the entire contents of which are hereby incorporated by reference.

### BACKGROUND

### 1. Field

A positive electrode for a rechargeable lithium battery and a rechargeable lithium battery including the same are disclosed.

### 2. Description of the Related Art

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery having high energy density as a driving power source or power storage power source for hybrid or electric vehicles. This rechargeable lithium battery requires a high-capacity electrode, but because there is a limit to increasing capacity of an active material itself, an amount of the active material has been increased, thereby making a thick-filmed electrode. Utilizing the thick-filmed electrode brings about a problem of reaction non-uniformity between upper and lower portions of the electrode. Accordingly, research on a method for solving this problem and smoothing an electrochemical reaction of the lower portion of the electrode is being conducted.

### SUMMARY

Embodiments of the present disclosure provide a positive electrode for a rechargeable lithium battery, which solves or improves the reaction non-uniformity between the upper and lower portions of the electrode and improves ion conductivity and an electrolyte impregnation degree of the lower portion of the electrode, and a rechargeable lithium battery which is manufactured by applying this positive electrode has high capacity and high energy and concurrently (e.g., simultaneously), exhibits improved cycle-life characteristics, rate capability, and the like.

In an embodiment, the positive electrode for a rechargeable lithium battery includes a current collector, a first positive electrode active material layer on the current collector and including a first positive electrode active material, and a second positive electrode active material layer on the first positive electrode active material layer and including a second positive electrode active material, wherein the first positive electrode active material layer includes ceramic particles, a particle diameter of each of the ceramic particles ranges from about 10 nm to about 500 nm, and the ceramic particles are included only in the first positive electrode active material layer.

In another embodiment, a rechargeable lithium battery includes the positive electrode, the negative electrode, a separator between the positive electrode and the negative electrode, and an electrolyte.

The positive electrode for a rechargeable lithium battery according to an embodiment has a high capacity, eliminates or reduces non-uniformity of reactions between the upper and lower portions of the electrode, and improves an electrolyte impregnation degree and an ionic conductivity of the lower portion of the electrode.

A rechargeable lithium battery according to another embodiment achieves high capacity and high energy while implementing improved cycle-life characteristics and rate capability.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a schematic view illustrating a rechargeable lithium battery according to an embodiment.

FIG. 2 is an evaluation graph of cycle-life characteristics of battery cells according to examples and comparative examples.

FIG. 3 is a graph showing rate capability evaluation of the battery cells according to the examples and comparative examples.

### DETAILED DESCRIPTION

Hereinafter, example embodiments will be described in more detail so that those of ordinary skill in the art can easily implement them. However, the subject matter of this disclosure may be embodied in many different forms and should not be construed as being limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, the term “layer,” as used herein, includes not only a shape formed on the whole surface when viewed from a plan view, but also a shape formed on a partial surface.

In addition, the average particle diameter may be measured by any suitable method generally used in the art. For example, the average particle diameter may be measured by a particle size analyzer, or may be measured by a transmission electron micrograph or a scanning electron micrograph. In some embodiments, it is possible to obtain an average particle diameter value by measuring using a dynamic light scattering method, performing data analysis, counting the number of particles for each particle size range, and calculating from this. Unless otherwise defined, the average particle diameter is measured by a particle size analyzer, and may refer to a diameter (D50) of particles having a cumulative volume of 50 volume % in the particle size distribution.

### Positive Electrode

In an embodiment, a positive electrode for a rechargeable lithium battery includes a current collector, a first positive electrode active material layer on the current collector and including a first positive electrode active material, and a second positive electrode active material layer on the first positive electrode active material layer and including a second positive electrode active material, wherein the first positive electrode active material layer includes ceramic particles having a particle diameter of about 10 nm to about 500 nm. The second positive electrode active material layer does not include ceramic particles. For example, the ceramic particles may be included in the first positive electrode active material layer alone. Thus, in some embodiments, the second positive electrode active material layer may be free of ceramic particles such that ceramic particles are only present in the second positive electrode active material layer, if at all, as an incidental impurity, or the second positive electrode active material layer may be completely free of ceramic particles.

In general, as a positive electrode active material layer is thicker, capacity is higher, but there is a problem of lowering an electrolyte impregnation degree in a lower portion of the active material layer close to a current collector, which results in a reaction that is not suitable or sufficient. On the contrary, the positive electrode for a rechargeable lithium battery according to an embodiment may not only accomplish high capacity, but also because the second positive electrode active material layer close to the surface of the positive electrode active material layer includes no ceramic particles, while the first positive electrode active material layer close to the current collector of the positive electrode active material layer includes the ceramic particles having a particle diameter of about 10 nm to about 500 nm, a porosity of the first positive electrode active material layer, that is, a lower portion of the electrode, may be increased, an electrolyte impregnation degree thereof may be increased, and accordingly, lithium ions move much more smoothly. In other words, reaction nonuniformity of upper and lower portions of an electrode plate is solved or improved. For example, including the ceramic particles having a particle diameter of about 10 nm to about 500 nm in the first positive electrode active material layer (the lower portion of the electrode) to increase the porosity of the first positive electrode active material layer, and having the second positive electrode active material layer (the upper portion of the electrode) increases reaction uniformity of the upper and lower portions of the electrode plate by making the respective reaction levels (e.g., respective amounts of lithium ion intercalation and deintercalation) of the upper and lower portions of the electrode plate more equal. As a uniform reaction of the upper and lower portions of the electrode plate are secured, cycle-life characteristics of a rechargeable lithium battery including the positive electrode may be improved. In addition, the lithium ions may smoothly move to the lower portion of the electrode plate and thus make the electrochemical reactions much more active, thereby improving rate capability of a rechargeable lithium battery and the like.

The ceramic particles may have a particle diameter of about 10 nm to about 500 nm, and, for example, about 10 nm to about 400 nm, about 10 nm to about 350 nm, about 10 nm to about 300 nm, about 30 nm to about 500 nm, about 50 nm to about 400 nm, or about 50 nm to about 350 nm. When the particle diameter of the ceramic particles satisfies the above ranges, the ceramic particles may be evenly dispersed in the first positive electrode active material layer, increase a porosity of the first positive electrode active material layer, so that the electrolyte is well impregnated, and the lithium ion conductivity is increased. Accordingly, cycle-life characteristics and rate capability of the rechargeable lithium battery may be improved. As used herein, the term “particle diameter” of the ceramic particles may refer to an average particle diameter (D50), wherein the average particle diameter (D50) indicates a particle where a cumulative volume is about 50 volume % in a particle distribution.

The ceramic particles may include, for example, Al₂O₃, SiO₂, ZrO₂, MgO, Na₂O, TiO₂, GeO₂, Li₂O—SiO₂—TiO₂—P₂O₅, Li₂O—Al₂O₃—TiO₂—P₂O₅, Li₂O—Al₂O₃—SiO₂—P₂O₅—TiO₂, Li₂O—Al₂O₃—SiO₂—P₂O₅—TiO₂—GeO₂, Li₃Al₁Ti₂Si₁ P₂O₁₂, Li_{1.5}Al_{0.5}Ge_{1.5}P₃O₁₂, Li_{1.3}Al_{0.3}Ti_{1.7}(PO₄)₃, Li₂S—P₂S₅, Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₂S, Li₂S—SiS₂, Li₂S—GeS₂, Li₂S—B₂S₅, Li₂S—Al₂S₂, CaF₂, AgI, or a combination thereof. For example, the ceramic particles have high ionic conductivity and satisfy the above particle size range, and may be one or more selected from Li₂O—SiO₂—TiO₂—P₂O₅, Li₂O—Al₂O₃—TiO₂—P₂O₅, Li₂O—Al₂O₃—SiO₂—P₂O₅—TiO₂, Li₂O—Al₂O₃—SiO₂—P₂O₅—TiO₂—GeO₂, and a combination thereof.

The ceramic particles may have an ion conductivity of about 10⁻⁸ S/cm to about 10⁻³ S/cm, and for example about 10⁻⁷ S/cm to about 10⁻³ S/cm, about 10⁻⁶ S/cm to about 10⁻³ S/cm, or about 10⁻⁶ S/cm to about 10⁻⁴ S/cm. The ceramic particles satisfying the above ionic conductivity range may help lithium ions to suitably or sufficiently move within the first positive electrode active material layer. Accordingly, cycle-life characteristics and rate capability of a rechargeable lithium battery may be improved.

The ceramic particles may be included in an amount of about 0.1 wt % to about 15 wt %, for example, about 0.1 wt % to about 13 wt %, about 0.1 wt % to about 11 wt %, about 0.1 wt % to about 10 wt %, about 0.1 wt % to about 8 wt %, about 0.1 wt % to about 6 wt %, about 0.1 wt % to about 5 wt %, about 0.5 wt % to about 15 wt %, about 1 wt % to about 15 wt %, about 2 wt % to about 15 wt %, or about 1 wt % to about 10 wt % based on 100 wt % of the first positive electrode active material layer. When the ceramic particles are included within the ranges, the ceramic particles may be evenly dispersed in the first positive electrode active material layer and thus increase a porosity of the first positive electrode active material layer so that an electrolyte may be well impregnated therein, and conductivity of the lithium ions may suitably or sufficiently be increased. Accordingly, cycle-life characteristics, rate capability, and the like of a rechargeable lithium battery may be improved.

The first positive electrode active material and the second positive electrode active material may be the same as or different from each other. The first positive electrode active material and the second positive electrode active material may be compounds capable of intercalating and deintercalating lithium and may each independently be compounds represented by Chemical Formula 1.

Liₐ₁M¹_{1-y1-z1}M²_{y1}M³_{z1}O₂ Chemical Formula 1

In Chemical Formula 1, 0.9≤a1≤1.2, 0≤y1≤1, 0≤z1≤1, 0≤y1+z1<1, and M¹, M², and M³ are each independently one of Ni, Co, Mn, Al, Sr, Mg, La, or a combination thereof.

In one example, M¹ of Chemical Formula 1 may be Ni, and M² and M³ may be independently a metal such as Co, Mn, Al, Sr, Mg, La, or the like. In another example, M¹ may be Ni, M² may be Co, and M³ may be Mn or Al but is not limited thereto.

In Chemical Formula 1, when M¹ is nickel, 1−y1−z1 indicating an amount of nickel may be greater than or equal to about 0.4, for example, greater than or equal to about 0.5, greater than or equal to about 0.6, greater than or equal to about 0.7, greater than or equal to about 0.8, greater than or equal to about 0.85, or greater than or equal to about 0.9 and less than or equal to about 0.99 or less than or equal to about 0.95. When the amount of nickel satisfies the ranges, battery capacity may not only be increased, but also excellent battery characteristics may be realized.

As another example, the first positive electrode active material and the second positive electrode active material may each independently be compounds represented by Chemical Formula 2.

Liₐ₂Niₓ₂M⁴_{y2}M⁵_{z2}O₂ Chemical Formula 2

In Chemical Formula 2, 0.9≤a2≤1.2, 0.90≤x2≤0.99, 0.005≤y2≤0.09, 0.005≤z2≤0.09, and x2+y2+z2=1, and M⁴ and M⁵ are each independently at least one element of Co, Mn, Al, Cr, Fe, V, Mg, Ti, Zr, Nb, Mo, W, Cu, Zn, Ga, In, Sn, La, or Ce.

In Chemical Formula 2, x2 indicates an amount of nickel is in a range of greater than or equal to about 0.90 and less than or equal to about 0.99, for example, about 0.90 to about 0.98, or about 0.90 to about 0.95. When the amount of nickel based on a total amount of metals excluding lithium is greater than or equal to about 90 mol % as shown in Chemical Formula 2, a battery including this positive electrode active material may realize very high capacity. In the positive electrode for a rechargeable lithium battery according to one embodiment, when the first positive electrode active material and/or the second positive electrode active material is a compound represented by Chemical Formula 2, high capacity may be accomplished, and concurrently (simultaneously), reaction uniformity of the upper and lower portions of an electrode plate may be secured, thereby solving problems that would otherwise arise due to the high capacity.

For example, the first positive electrode active material and the second positive electrode active material may be each independently compounds represented by Chemical Formula 3.

Liₓ₂Ni_{y2}Co_{z2}Al_{1-y2-z2}O₂ Chemical Formula 3

In Chemical Formula 3, 0.9≤x2≤1.2, 0.5≤y2≤1, and 0≤z2≤0.5. In some embodiments, in Chemical Formula 3, 0.6≤y2≤1 and 0≤z2≤0.4, 0.7≤y2≤1 and 0≤z2≤0.8≤y2≤1 and 0≤z2≤0.2, or0.9≤y2≤1 and 0≤z2≤0.1. In the positive electrode for a rechargeable lithium battery according to one embodiment, when the first positive electrode active material and/or the second positive electrode active material is a compound represented by Chemical Formula 3, high capacity may be accomplished, and concurrently (simultaneously), reaction uniformity of upper and lower portions of an electrode plate may be secured, thereby solving problems that would otherwise arise due to the high capacity.

The first positive electrode active material may have a particle diameter of about 1 μm to about 25 μm, for example, about 1 μm to about 20 μm, or about 3 μm to about 20 μm. When the first positive electrode active material has a particle diameter satisfying the ranges, the first positive electrode active material may be evenly mixed together with ceramic particles which are added thereto, so that an electrolyte may be well impregnated to the first positive electrode active material layer and actively maintain a lithium ion movement, and accordingly, even when high capacity is accomplished by thickening an electrode plate, reaction non-uniformity of the upper and lower portions of the electrode plate may be solved or improved, thereby improving cycle-life characteristics, rate capability, and the like of a battery.

The first positive electrode active material may be a bimodal active material in which a large particle diameter active material and a small particle diameter active material are mixed together. A particle diameter of the large particle diameter active material may be, for example, greater than or equal to about 12 μm, greater than or equal to about 13 μm, greater than or equal to about 14 μm, or greater than or equal to about 15 μm, and less than or equal to about 25 μm, less than or equal to about 22 μm, or less than or equal to about 20 μm. A particle diameter of the small particle diameter active material may be for example greater than or equal to about 1 μm, greater than or equal to about 2 μm, or greater than or equal to about 3 μm, and less than or equal to about 8 μm, less than or equal to about 7 μm, less than or equal to about 6 μm, or less than or equal to about 5 μm.

In addition, a mixing ratio of the large particle diameter active material and the small particle diameter active material may be about 90:10 to about 50:50, or about 90:10 to about 70:30 by weight. In this way, when a bimodal active material is utilized, a mixture density of the electrode plate may be improved, thereby obtaining a battery having excellent capacity characteristics per volume, the ceramic is evenly mixed in the first positive electrode active material layer to well impregnate an electrolyte to the first positive electrode active material layer and actively maintain a lithium ion movement, and accordingly, even when the electrode plate is thickened to accomplish high capacity, reaction non-uniformity of the upper and lower portions of the electrode plate may be solved or improved, thereby improving cycle-life characteristics, rate capability, and the like of a battery.

The particle diameter of the second positive electrode active material may be about 1 μm to about 25 μm, for example, about 1 μm to about 20 μm, or about 3 pm to about 20 μm. When the second positive electrode active material included in the second positive electrode active material layer corresponding to the upper portion of the electrode plate has a particle diameter within the ranges, an electrolyte may well penetrate to the lower portion of the electrode plate and help lithium ions smoothly move, accomplishing high capacity and concurrently (simultaneously), improving cycle-life characteristics, rate capability, and the like of a battery.

The second positive electrode active material may be a bimodal active material in which a large particle diameter active material and a small particle diameter active material are mixed together. A particle diameter of the large particle diameter active material may be, for example, greater than or equal to about 12 μm, greater than or equal to about 13 μm, greater than or equal to about 14 μm, or greater than or equal to about 15 μm, and less than or equal to about 25 μm, less than or equal to about 22 μm, or less than or equal to about 20 μm. A particle diameter of the small particle diameter active material may be for example greater than or equal to about 1 μm, greater than or equal to about 2 μm, or greater than or equal to about 3 μm and less than or equal to about 8 μm, less than or equal to about 7 μm, less than or equal to about 6 μm, or less than or equal to about 5 μm. In addition, a mixing ratio of the large particle diameter active material and small particle diameter active material may be about 90:10 to about 50:50, or about 90:10 to about 70:30 by weight. In this way, when a bimodal active material is utilized, a mixture density of an electrode plate is improved, thereby obtaining a battery having excellent capacity characteristics per volume, and in addition, the active material may help an electrolyte well penetrate to the lower portion of the electrode plate and lithium ions smoothly move and thus accomplish high capacity and concurrently (simultaneously), improve cycle-life characteristics, rate capability, and the like of the battery.

In some embodiments, the first positive electrode active material layer and/or the second positive electrode active material layer may further include a conductive material (e.g., an electrically conductive material) and the conductive material may be included in an amount of about 0.1 wt % to about 5 wt %, or about 0.1 wt % to about 4 wt %, about 0.1 wt % to about 3 wt %, or about 1 wt % to about 5 wt % based on 100 wt % of the first positive electrode active material layer, or 100 wt % of the second positive electrode active material layer.

The conductive material is used to impart conductivity (e.g., electrical conductivity) to the electrode, and may include, for example, a carbon-based material such as natural graphite, artificial graphite, carbon black, acetylene black, ketjen black, a carbon fiber, a carbon nanofiber, and/or a carbon nanotube; a metal-based material containing copper, nickel, aluminum, silver, and/or the like in the form of a powder and/or a fiber; a conductive polymer such as a polyphenylene derivative; and/or a mixture thereof.

In addition, the first positive electrode active material layer and/or the second positive electrode active material layer may further include a binder, and the binder may be included in an amount of about 0.1 wt % to about 5 wt % about 0.1 wt % to about 4 wt %, about 0.1 wt % to about 3 wt %, or about 1 wt % to about 5 wt % based on 100 wt % of the first positive electrode active material layer, or 100 wt % of the second positive electrode active material layer.

The binder improves binding properties of positive electrode active material particles with one another and with a current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

In the first positive electrode active material layer, the binder may have an amorphous form due to the added ceramic particles. The binder changed into the amorphous form (or having an amorphous form) may increase an amount of the electrolyte impregnated in the first positive electrode active material layer and make the lithium ion movement much smoother. Accordingly, cycle-life characteristics and rate capability of a battery may be improved.

When the first positive electrode active material layer further includes a conductive material (e.g., an electrically conductive binder) and a binder, based on 100 wt % of the first positive electrode active material layer, the first positive electrode active material may be included in an amount of about 75 wt % to about 99 wt %, the ceramic particles may be included in an amount of about 0.1 wt % to about 15 wt %, the conductive material may be included in an amount of about 0.1 wt % to about 5 wt %, and the binder may be included in an amount of about 0.1 wt % to about 5 wt %. When the contents of the components in the first positive electrode active material layer respectively satisfy the foregoing ranges, the ceramic particles may be evenly dispersed in the first positive electrode active material layer, while high capacity is maintained, an electrolyte impregnation degree of the first positive electrode active material layer and conductivity of lithium ions may be increased, thereby accomplishing reaction uniformity of upper and lower portions of an electrode plate and resultantly, improving capacity characteristics, cycle-life characteristics, rate capability, and the like of a battery.

The content of the first positive electrode active material may be suitably or appropriately adjusted according to the contents of other components, for example, about 78 wt % to about 99 wt %, about 80 wt % to about 99 wt %, about 85 wt % to about 99 wt %, about 90 wt % to about 99 wt %, about 75 wt % to about 97 wt %, about 75 wt % to about 95 wt %, or about 75 wt % to about 90 wt % based on 100 wt % of the first positive electrode active material layer.

When the second positive electrode active material layer further includes a conductive material (e.g., an electrically conductive material) and a binder, the second positive electrode active material may be included in an amount of about 90 wt % to about 99 wt % based on 100 wt % of the second positive electrode active material layer, the conductive material may be included in an amount of about 0.1 wt % to about 5 wt %, and the binder may be included in an amount of about 0.1 wt % to about 5 wt %. In the second positive electrode active material layer, when the contents of the components respectively satisfy the ranges, high capacity is maintained, and concurrently (simultaneously), reaction uniformity of the upper and lower portions of the electrode plate may be accomplished.

In some embodiments, the positive electrode active material layer including the first positive electrode active material layer and the second positive electrode active material layer may have a total thickness of about 40 μm to about 300 μm, for example, about 50 μm to about 300 μm, about 60 μm to about 300 μm, about 70 μm to about 300 μm, about 80 μm to about 300 μm, about 40 μm to about 250 μm, about 40 μm to about 200 μm, or about 40 μm to about 150 μm. The total thickness of the positive electrode active material layer may be thicker than those of existing electrode plates and thus in a range capable of accomplishing high capacity. In the positive electrode according to one embodiment, when the total thickness of the positive electrode active material layer satisfies the foregoing ranges, high capacity may be accomplished, and concurrently (simultaneously), reaction non-uniformity of upper and lower portions of an electrode plate may be solved or improved, improving the problems that would otherwise arise due to thickening of an electrode plate.

The first positive electrode active material layer may have a thickness of about 20 μm to about 150 μm, for example, about 20 μm to about 120 μm, about 20 pm to about 100 μm, about 20 μm to about 80 μm, about 30 μm to about 150 μm, about 30 μm to about 100 μm, or about 30 μm to about 80 μm. When the thickness of the first positive electrode active material layer satisfies the ranges, high capacity may be accomplished, and in addition, reaction uniformity of the upper and lower portions of the electrode plate may be secured.

A thickness of the second positive electrode active material layer may be in a range of about 20 μm to about 150 μm, for example, about 20 μm to about 120 μm, about 20 μm to about 100 μm, about 20 μm to about 80 μm, about 30 μm to about 150 μm, or about 40 μm to about 150 μm. When the thickness of the second positive electrode active material layer satisfies the foregoing ranges, high capacity may be accomplished, and in addition, reaction uniformity of the upper and lower portions of the electrode plate may be secured.

In the positive electrode for a rechargeable lithium battery according to an embodiment, the current collector may be made of an aluminum foil, a copper foil, a nickel foil, a stainless-steel foil, a titanium foil, a nickel foam, a copper foam, a polymer substrate coated with a conductive metal, or a combination thereof.

### Rechargeable Lithium Battery

Another embodiment provides a rechargeable lithium battery including the aforementioned positive electrode, the negative electrode, a separator and an electrolyte between the positive electrode and the negative electrode.

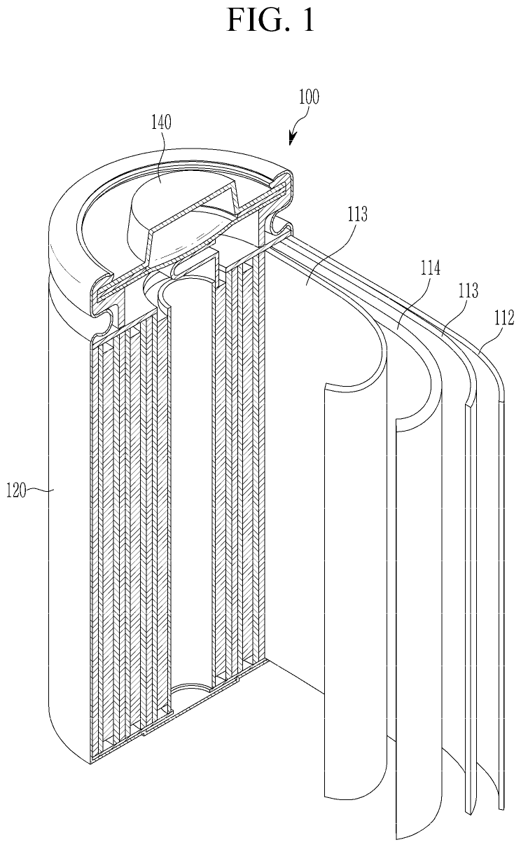

FIG. 1 is a schematic view illustrating a rechargeable lithium battery according to an embodiment. Referring to FIG. 1, a rechargeable lithium battery 100 according to an embodiment of the present disclosure includes a battery cell including a positive electrode 114, a negative electrode 112 facing the positive electrode 114, a separator 113 between the positive electrode 114 and the negative electrode 112, and an electrolyte for a rechargeable lithium battery impregnated in the positive electrode 114, negative electrode 112, and separator 113, a battery case 120 housing the battery cell, and a sealing member 140 sealing the battery case 120.

The negative electrode 112 for a rechargeable lithium battery includes a current collector and a negative electrode active material layer formed on the current collector and including a negative electrode active material.

The negative electrode active material may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include, for example, crystalline carbon, amorphous carbon, or a combination thereof as a carbon-based negative electrode active material. The crystalline carbon may be non-shaped, or plate, flake, spherical, or fiber shaped natural graphite or artificial graphite. The amorphous carbon may be a soft carbon, a hard carbon, a mesophase pitch carbonization product, calcined coke, and/or the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material and/or a Sn-based negative electrode active material. The Si-based negative electrode active material may include silicon, a silicon-carbon composite, SiOₓ (0<x<2), a Si-Q alloy, wherein Q is an alkali metal, an alkaline-earth metal, a Group 13 element, a Group 14 element, a Group 15 element, a Group 16 element, a transition metal, a rare earth element, and a combination thereof, but not Si and the Sn-based negative electrode active material may include Sn, SnO₂, a Sn—R alloy, wherein R is an alkali metal, an alkaline-earth metal, a Group 13 element, a Group 14 element, a Group 15 element, a Group 16 element, a transition metal, a rare earth element, and a combination thereof, but not Sn. At least one of these materials may be mixed together with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be a silicon-carbon composite including a core including crystalline carbon and silicon particles and an amorphous carbon coating layer on the surface of the core. The crystalline carbon may be artificial graphite, natural graphite, or a combination thereof. The amorphous carbon precursor may be a coal-based pitch, a mesophase pitch, a petroleum-based pitch, a coal-based oil, a petroleum-based heavy oil, and/or a polymer resin such as a phenol resin, a furan resin, and/or a polyimide resin. In some embodiments, the content of silicon may be about 10 wt % to about 50 wt % based on the total weight of the silicon-carbon composite. In some embodiments, the content of the crystalline carbon may be about 10 wt % to about 70 wt % based on the total weight of the silicon-carbon composite, and the content of the amorphous carbon may be about 20 wt % to about 40 wt % based on the total weight of the silicon-carbon composite. In addition, a thickness of the amorphous carbon coating layer may be about 5 nm to about 100 nm. An average particle diameter (D50) of the silicon particles may be about 10 nm to about 20 μm. The average particle diameter (D50) of the silicon particles may be, for example, about 10 nm to about 200 nm. The silicon particles may exist in an oxidized form, and in some embodiments, an atomic content ratio of Si:O in the silicon particles indicating a degree of oxidation may be about 99:1 to about 33:67. The silicon particles may be SiOₓ particles, and in some embodiments, the range of x in SiOₓ may be greater than about 0 and less than about 2. In the present specification, unless otherwise defined, an average particle diameter (D50) indicates a diameter of a particle where a cumulative volume is about 50 volume % in a particle size distribution.

The Si-based negative electrode active material and/or the Sn-based negative electrode active material may be mixed together with the carbon-based negative electrode active material. When the Si-based negative electrode active material or Sn-based negative electrode active material and the carbon-based negative electrode active material are mixed together and used, the mixing ratio may be a weight ratio of about 1:99 to about 10:90.

In the negative electrode active material layer, the negative electrode active material may be included in an amount of about 95 wt % to about 99 wt % based on the total weight of the negative electrode active material layer.

In an embodiment, the negative electrode active material layer includes a binder, and may optionally further include a conductive material. The content of the binder in the negative electrode active material layer may be about 1 wt % to about 5 wt % based on the total weight of the negative electrode active material layer. In addition, when the conductive material is further included, the negative electrode active material layer may include about 90 wt % to about 98 wt % of the negative electrode active material, about 1 wt % to about 5 wt % of the binder, and about 1 wt % to about 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder and/or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity may be further included as a thickener. As the cellulose-based compound, one or more of carboxymethyl cellulose, hydroxypropylmethyl cellulose, methyl cellulose, or alkali metal salts thereof may be mixed together and used. As the alkali metal, Na, K or Li may be used. The amount of the thickener used may be about 0.1 parts by weight to about 3 parts by weight based on 100 parts by weight of the negative electrode active material.

The conductive material is included to provide electrode conductivity (e.g., electrical conductivity). Any suitable electrically conductive material may be used as a conductive material unless it causes a chemical change (e.g., an undesirable chemical change). Examples of the conductive material include a carbon-based material such as natural graphite, artificial graphite, carbon black, acetylene black, ketjen black, a carbon fiber, and the like; a metal-based material of a powder or a fiber including copper, nickel, aluminum, silver, and the like; a conductive polymer such as a polyphenylene derivative; or a mixture thereof.

The current collector may include one selected from a copper foil, a nickel foil, a stainless-steel foil, a titanium foil, a nickel foam, a copper foam, a polymer substrate coated with a conductive metal, and a combination thereof.

The electrolyte is also referred to an electrolyte solution, and includes a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, alcohol-based solvent, and/or an aprotic solvent. Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. Examples of the ester-based solvent include methyl acetate, ethyl acetate, n-propyl acetate, dimethyl acetate, methyl propionate, ethyl propionate, γ-butyrolactone, decanolide, valerolactone, mevalonolactone, caprolactone, and the like. The ether-based solvent may be dibutyl ether, tetraglyme, diglyme, dimethoxyethane, 2-m ethyltetrahydrofuran, tetrahydrofuran, and/or the like and the ketone-based solvent may be cyclohexanone, and/or the like. In addition, the alcohol-based solvent may be ethyl alcohol, isopropyl alcohol, etc. and the aprotic solvent may be nitriles such as R—CN, where R includes a C2 to C20 linear, branched, and/or cyclic hydrocarbon group and may include a double bond, an aromatic ring, and/or an ether bond, amides such as dimethylformamide, dioxolanes such as 1,3-dioxolane, sulfolanes, and/or the like.

The non-aqueous organic solvent may be used alone or in a mixture. When the organic solvent is used in a mixture, the mixture ratio may be controlled in accordance with a suitable or desirable battery performance.

In addition, in embodiments including the carbonate-based solvent, a mixture of a cyclic carbonate and a chain carbonate may be used. In some embodiments, when the cyclic carbonate and the chain carbonate are mixed together in a volume ratio of about 1:1 to about 1:9, the electrolyte solution may exhibit excellent performance.

The non-aqueous organic solvent may further include an aromatic hydrocarbon-based organic solvent in addition to the carbonate-based solvent. In some embodiments, the carbonate-based solvent and the aromatic hydrocarbon-based organic solvent may be mixed together in a volume ratio of about 1:1 to about 30:1.

The aromatic hydrocarbon-based solvent may be an aromatic hydrocarbon-based compound represented by Chemical Formula I.

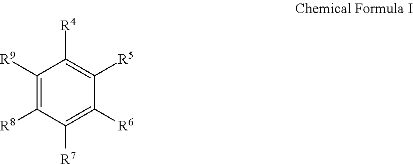

In Chemical Formula I, R⁴ to R⁹ are the same or different and are selected from hydrogen, a halogen, a C1 to C10 alkyl group, a haloalkyl group, and a combination thereof.

Examples of the aromatic hydrocarbon-based solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte solution may further include vinylene carbonate or an ethylene carbonate-based compound represented by Chemical Formula II as additive in order to improve cycle-life of a battery.

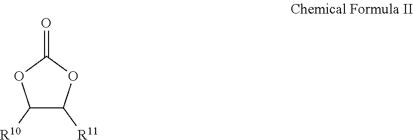

In Chemical Formula II, R¹⁹ and R¹¹ are the same or different and selected from hydrogen, a halogen, a cyano group, a nitro group, and a fluorinated C1 to C5 alkyl group, provided that at least one of R¹⁰ and R¹¹ is a halogen, a cyano group, a nitro group, and a fluorinated C1 to C5 alkyl group, and R¹⁰ and R¹¹ are not simultaneously hydrogen (are not both hydrogen).

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle-life may be used within a suitable or appropriate range.

The lithium salt dissolved in the non-aqueous organic solvent supplies lithium ions in a battery, enables a basic operation of a rechargeable lithium battery, and improves transportation of the lithium ions between positive and negative electrodes.

Examples of the lithium salt include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, for example, an integer ranging from 1 to 20, lithium difluoro(bisoxalato) phosphate, LiCl, LiI, LiB(C₂O₄)₂ (lithium bis(oxalato) borate, LiBOB), and lithium difluoro(oxalato)borate (LiDFOB).

The lithium salt may be used in a concentration in a range from about 0.1 M to about 2.0 M. When the lithium salt is included at the above concentration range, an electrolyte may have excellent performance and lithium ion mobility due to suitable or optimal electrolyte conductivity and viscosity.

The separator 113 separates a positive electrode 114 and a negative electrode 112 and provides a transporting passage for lithium ions and may be any suitable separator generally-used in a lithium ion battery. In some embodiments, the separator 113 may have low resistance to ion transport and excellent impregnation for an electrolyte solution. For example, separator may include a glass fiber, polyester, polyethylene, polypropylene, polytetrafluoroethylene, and a combination thereof. It may have a form of a non-woven fabric or a woven fabric. For example, in a lithium ion battery, a polyolefin-based polymer separator such as polyethylene and/or polypropylene is mainly used. In order to ensure the heat resistance and/or mechanical strength, a coated separator including a ceramic component and/or a polymer material may be used. Optionally, it may have a mono-layered or multi-layered structure.

Rechargeable lithium batteries may be classified as lithium ion batteries, lithium ion polymer batteries, and lithium polymer batteries according to the presence of a separator and the type or kind of electrolyte used therein. The rechargeable lithium batteries may have a variety of suitable shapes and sizes, and include cylindrical, prismatic, coin, or pouch-type batteries, and may be thin film batteries or may be rather bulky in size. Structures and manufacturing methods for lithium ion batteries pertaining to this disclosure should be readily understood by those having ordinary skill in the art.

Hereinafter, examples of embodiments of the present disclosure and comparative examples are described. It is to be understood, however, that the examples are for the purpose of illustration and are not to be construed as limiting the present disclosure.

### EXAMPLE 1

### (1) Manufacture of Positive Electrode

A first positive electrode active material slurry was prepared by using 94.8 wt % of Li_{1±a}Ni_{0.916}Co_{0.07}Al_{0.014}O₂, a positive electrode active material prepared by mixing together a large particle diameter active material having a particle diameter of about 17 μm and a small particle diameter active material having a particle diameter of about 3 μm to 5 μm in a weight ratio of 8:2, 1.2 wt % of PVDF as a binder, 1.1 wt % of CNT as a conductive material, and 2.9 wt % of ceramic particles of Li₂O—SiO₂—TiO₂—P₂O₅ (a particle diameter: about 200 nm, ion conductivity: 10⁻⁶ to 10⁻⁵ S/cm) in an NMP solvent. The prepared first positive electrode active material slurry was coated on one surface of a 15 μm-thick Al current collector and dried, forming a first positive electrode active material layer on the current collector. The first positive electrode active material layer had a thickness of 30 μm.

A second positive electrode active material slurry was prepared by mixing together 97.7 wt % of Li_{1±a}Ni_{0.916}Co_{0.07}Al_{0.014}O₂ as a positive electrode active material, 1.2 wt % of PVDF as a binder, and 1.1 wt % of CNT as a conductive material in an NMP solvent. The prepared second positive electrode active material slurry was coated on the first positive electrode active material layer and then, dried and compressed to have an electrode plate density of 3.6 g/cc, forming a second positive electrode active material layer on the first positive electrode active material layer and thus manufacturing a positive electrode wherein the current collector, the first positive electrode active material layer, and the second positive electrode active material layer were sequentially stacked. The second positive electrode active material layer had a thickness of 30 μm. The ceramic particles were added only to the first positive electrode active material layer.

### (2) Manufacture of Negative Electrode

97.3 wt % of graphite as a negative electrode active material, 0.5 wt % of denka black, 0.9 wt % of carboxylmethyl cellulose, and 1.3 wt % of styrenebutadiene rubber were mixed together in an aqueous solvent to prepare a negative electrode active material slurry. The prepared negative electrode active material slurry was coated on a copper foil, dried, and compressed, manufacturing a negative electrode.

### (3) Manufacture of Battery Cell

The positive electrode, a separator having a polyethylene/polypropylene multi-layered structure, and the negative electrode were sequentially stacked to manufacture a pouch-type cell, and an electrolyte prepared by adding 1.0 M of a LiPF₆ lithium salt in a mixed solvent of ethylene carbonate and diethyl carbonate in a volume ratio of 50:50 was injected thereinto, manufacturing a rechargeable lithium battery cell.

### EXAMPLE 2

A positive electrode, a negative electrode, and a battery cell were manufactured in substantially the same manner as Example 1 except that the positive electrode was manufactured by using 92.8 wt % of the positive electrode active material and 4.9 wt % of the ceramic particles.

### Comparative Example 1

A positive electrode, a negative electrode, and a battery cell were manufactured in substantially the same manner as Example 1 except that the positive electrode was manufactured as a 60 μm-thick single layer including no ceramic particles by coating the second positive electrode active material layer on the current collector without the first positive electrode active material layer and then, drying and compressing it. Comparative Example 1 is a case of a single-layered positive electrode including no ceramic particles.

### Comparative Example 2

A positive electrode, a negative electrode, and a battery cell were manufactured in substantially the same manner as Example 1 except that the positive electrode was manufactured by sequentially stacking the current collector, the second positive electrode active material layer, and the first positive electrode active material layer in order. Comparative Example 2 is a case of a positive electrode including the ceramic particles not in a lower portion of an electrode plate but in an upper portion thereof.

### Evaluation Example 1: Evaluation of Cycle-life Characteristics of Battery Cells

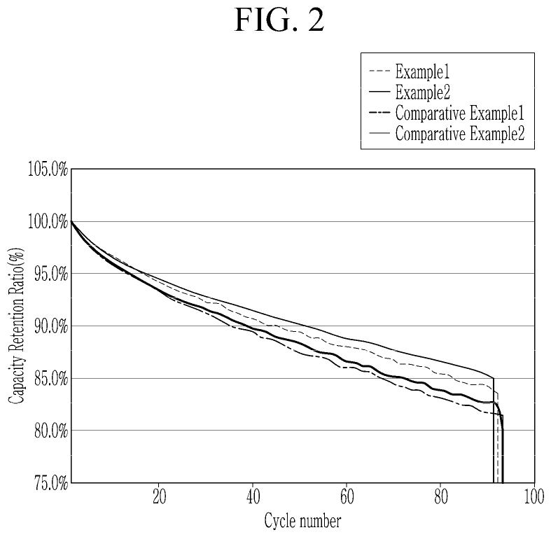

The rechargeable lithium battery cells according to Examples 1 to 2 and Comparative Examples 1 to 2 were charged to a voltage of 4.25 V at a 1.0 C rate and 45° C. under constant current and then, cut off at a 0.05 C rate, while maintained at 4.25 V in the constant voltage mode. Then, the cells were discharged to a voltage of 2.8 V at a 1.0 C rate, and this cycle was 100 times repeated. After every charge/discharge cycle in all charge/discharge cycles, a 10-minute pause was set. Capacity change according to the cycles is shown in FIG. 2.

Referring to FIG. 2, the cells of Examples 1 to 2 exhibited greatly excellent cycle-life characteristics compared with the cells of Comparative Examples 1 to 2.

### Evaluation Example 2: Evaluation of Rate Capability of Battery Cells

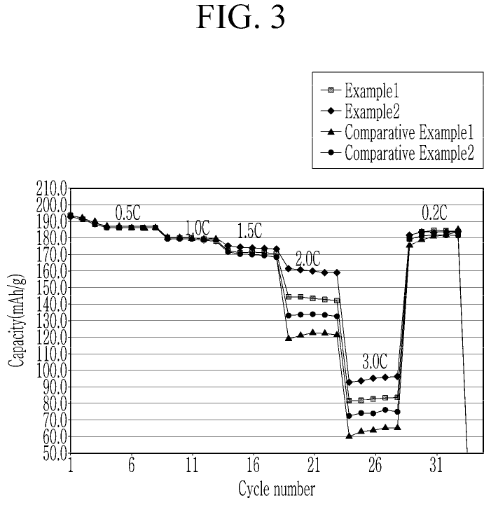

The rechargeable lithium battery cells according to Examples 1 to 2 and Comparative Examples 1 to 2 were constant current-charged to a voltage of 4.25 V at a 0.5 C current rate and cut off at a 0.05 C rate while maintained at 4.25 V in the constant voltage mode at 25° C. Subsequently, the cells were discharged to 2.8 V at a 0.5 C rate. Then, the charge was equally performed, while the discharge was respectively performed at a 1.0 C rate, a 1.5 C rate, a 2.0 C rate, a 3.0 C rate, and a 0.2 C rate, obtaining capacity at each discharge and thus evaluating rate capability, and the results are shown in FIG. 3.

Referring to FIG. 3, Examples 1 and 2 exhibited greatly excellent rate capability, compared with Comparative Examples 1 and 2.

While the subject matter of this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

100: rechargeable lithium battery
112: negative electrode
113: separator
114: positive electrode
120: battery case
140: sealing member

What is claimed is:

1. A positive electrode for a rechargeable lithium battery, comprising:
a current collector,
a first positive electrode active material layer on the current collector and comprising a first positive electrode active material, and
a second positive electrode active material layer on the first positive electrode active material layer and comprising a second positive electrode active material,
wherein the first positive electrode active material layer comprises ceramic particles, the ceramic particles have a particle diameter of 10 nm to 500 nm, and the ceramic particles are included only in the first positive electrode active material layer.

2. The positive electrode of claim 1, wherein the ceramic particles comprise Al₂O₃, SiO₂, ZrO₂, MgO, Na₂O, TiO₂, GeO₂, Li₂O—SiO₂—TiO₂—P₂O₅, Li₂O—Al₂O₃—TiO₂—P₂O₅, Li₂O—Al₂O₃—SiO₂—P₂O₅—TiO₂, Li₂O—Al₂O₃—SiO₂—P₂O₅—TiO₂—GeO₂, Li₃Al₁Ti₂Si₁P₂O₁₂, Li_{1.5}Al_{0.5}Ge_{1.5}P₃O₁₂, Li_{1.3}Al_{0.3}Ti_{1.7}(PO₄)₃, Li₂S—P₂S₅, Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₂S, Li₂S—SiS₂, Li₂S—GeS₂, Li₂S—B₂S₅, Li₂S—Al₂S₂, CaF₂, AgI, or a combination thereof.

3. The positive electrode of claim 1, wherein the ceramic particles have an ion conductivity of about 10⁻⁸ S/cm to about 10⁻³ S/cm.

4. The positive electrode of claim 1, wherein the ceramic particles are included in the first positive electrode active material layer an amount of about 0.1 wt % to about 15 wt % based on 100 wt % of the first positive electrode active material layer.

5. The positive electrode of claim 1, wherein the first positive electrode active material and the second positive electrode active material are the same.

6. The positive electrode of claim 1, wherein the first positive electrode active material and the second positive electrode active material are different from each other.

7. The positive electrode of claim 1, wherein the first positive electrode active material and the second positive electrode active material are each independently compounds represented by Chemical Formula 1:
Liₐ₁M¹_{1-31 y1-z1}M²_{y1}M³_{z1}O₂ Chemical Formula 1
wherein, in Chemical Formula 1, 0.9≤a1≤1.2, 0≤y1≤1, 0≤z1≤1, 0≤y1+z1<1, and M¹, M², and M³ are each independently one of Ni, Co, Mn, Al, Sr, Mg, La, or a combination thereof.

8. The positive electrode of claim 1, wherein the first positive electrode active material and the second positive electrode active material are each independently compounds represented by Chemical Formula 2:
Liₐ₂Niₓ₂M⁴_{y2}M⁵_{z2}O₂ Chemical Formula 2
wherein, in Chemical Formula 2, 0.9≤a2≤1.2, 0.90≤x2≤0.99, 0.005≤y2≤0.09, 0.005≤z2≤0.09, x2+y2+z2=1, and M⁴ and M⁵ are each independently at least one element of Co, Mn, Al, Cr, Fe, V, Mg, Ti, Zr, Nb, Mo, W, Cu, Zn, Ga, In, Sn, La, or Ce.

9. The positive electrode of claim 1, wherein the first positive electrode active material includes a large particle diameter active material having a particle diameter in a range from about 12 μm to about 25 μm and a small particle diameter active material having a particle diameter in a range from about 1 μm to about 8 μm.

10. The positive electrode of claim 1, wherein the second positive electrode active material includes a large particle diameter active material having a particle diameter in a range from about 12 μm to about 25 μm and a small particle diameter active material having a particle diameter in a range from about 1 μm to about 8 μm.

11. The positive electrode of claim 1, wherein:
the first positive electrode active material layer further includes a conductive material and a binder, and
based on 100 wt % of the first positive electrode active material layer,
the first positive electrode active material is included in an amount of about 75 wt % to about 99 wt %,
the ceramic particles are included in an amount of about 0.1 wt % to about 15 wt %,
the conductive material is included in an amount of about 0.1 wt % to about 5 wt %, and
the binder is included in an amount of about 0.1 wt % to about 5 wt %.

12. The positive electrode of claim 1, wherein:
the second positive electrode active material layer further includes a conductive material and a binder, and
based on 100 wt % of the second positive electrode active material layer 100 wt %,
the second positive electrode active material is included in an amount of about 90 wt % to about 99 wt %,
the conductive material is included in an amount of about 0.1 wt % to about 5 wt %, and
the binder is included in an amount of about 0.1 wt % to about 5 wt %.

13. The positive electrode of claim 1, wherein the first positive electrode active material layer has a thickness of about 20 μm to about 150 μm.

14. The positive electrode of claim 1, wherein the second positive electrode active material layer has a thickness of about 20 μm to about 150 μm.

15. A rechargeable lithium battery, comprising:
the positive electrode of claim 1,
a negative electrode,
a separator between the positive electrode and the negative electrode, and
an electrolyte.
